(19) United States
(12) Patent Application Publication
(10) Pub. No.: US 2003/0164775 A1
(43) Pub. Date: Sep. 4, 2003

(54) Emergency warning device

(76) Inventors: James Brooks Hutchison, Milton Keynes (GB); Beverley Marks, Battle (GB)

Correspondence Address: Edwin D Schindler, Five Hirsch Avenue, P O Box 966, Coram, NY, 11727-0966, US

(21) Appl. No.: 10/344,973

(22) PCT Filed: Aug. 17, 2001
(86) PCT No.: PCT/GB01/03720

(30) Foreign Application Priority Data
Aug. 17, 2000 (GB) 0020123.6

(51) Int. Cl. G08G 1/00

(52) U.S. Cl. 340/902

(57) ABSTRACT

A warning device D is fitted to an emergency vehicle and is arranged when deactivated, to transmit a radio signal carrying an audio warning,. this radio signal being transmitted repeatedly at successively different carrier frequencies, corresponding to the channels available in the local area. The VHF/FM radio receiver of any vehicle within range will tune to the signal of one of these carrier frequencies, as being identical or close to, but stronger than, the channel selected by the driver, so that the audio warning will be delivered to the driver.

The present invention relates to a device for use by an emergency service vehicle, to warn other road users of its presence.

Frequently, when an emergency service vehicle is travelling in heavy or even moderate traffic, its progress is impeded because other road users are slow to become aware of the approach of the emergency service vehicle, despite its use of its sirens. This problem is suffered by all emergency service vehicles, including ambulances, fire and rescue vehicles and police and paramedic cars.

A marked deterioration has been noticed, over recent years, in the way that road users react when an emergency service vehicle approaches. This is due mainly to improved sound proofing in cars and other vehicles and the use of more powerful sound systems, producing higher sound levels, such that there is an increased likelihood that the siren of the emergency service vehicle will not be heard, or at least will not be heard sufficiently early.

I have now devised a warning device which substantially alleviates the above-described problems.

In accordance with the present invention, there is provided a warning device for fitting to an emergency service vehicle, the device being arranged, when activated, to transmit a radio signal carrying an audio warning, said radio signal being transmitted repeatedly at successively different carrier frequencies.

The different carrier frequencies, at which the warning device transmits its radio signal, may be selectively programmable. Thus, for use of the warning device, or emergency service vehicle to which it is fitted, in any particular location, the different carrier frequencies, at which the device operates, may be selected to match the available radio broadcast channels, or at least the most popular channels, used in the operating area. Accordingly, the warning device may be arranged to transmit its radio signal at a relatively small number of different carrier frequencies, say between 5 and 15 and most probably between 7 and 10.

The radio signal is transmitted at the different carrier frequencies in sequential manner, rather than simultaneously, to make use of the FM capture effect in receivers and to avoid the effect of intermodulation between signals at different carrier frequencies in the warning device.

It will be appreciated that the VHF/FM radio receiver of any vehicle within range will tune to a stronger signal of identical or closely adjacent carrier frequency. The radio signal transmitted by the warning device of the present invention will therefore over-ride the signal being received by a vehicle's VHF/FM radio receiver tuned to a corresponding channel, for the warning message to be relayed over that unit.

Preferably the audio warning, provided by the warning device, is a spoken message, such as “Emergency Vehicle Approaching”. Preferably the warning device includes a voice chip or voice synthesiser for generating the audio message.

The radio transmitter of the warning device need have only a very low radiated power level giving limited range, preferably of the order of 100 to 300 metres, so that only road users within the immediate vicinity are affected.

Preferably the radio signal transmitted by the warning device includes RDS data which is recognised by the RDS decoder of the VHF/FM radio receiver of any vehicle within range, serving to interrupt the operation of the receiver, if replaying a tape cassette or CD, to deliver the warning message instead.

Optionally, the RDS data may be acquired by the warning device automatically, using an inbuilt scanning RDS radio receiver, arranged to scan the whole FM band and assess the signal strengths of channels transmitted in the area of usage. The device then stores the carrier frequencies of those channels and uses them, in sequence, for transmission of the warning radio signal: also the device decodes and stores the RDS data of the channels concerned, and inserts this RDS data into the RDS data set transmitted in the warning signal.

An embodiment of the present invention will now be described by way of example only and with reference to the accompanying drawings, in which:

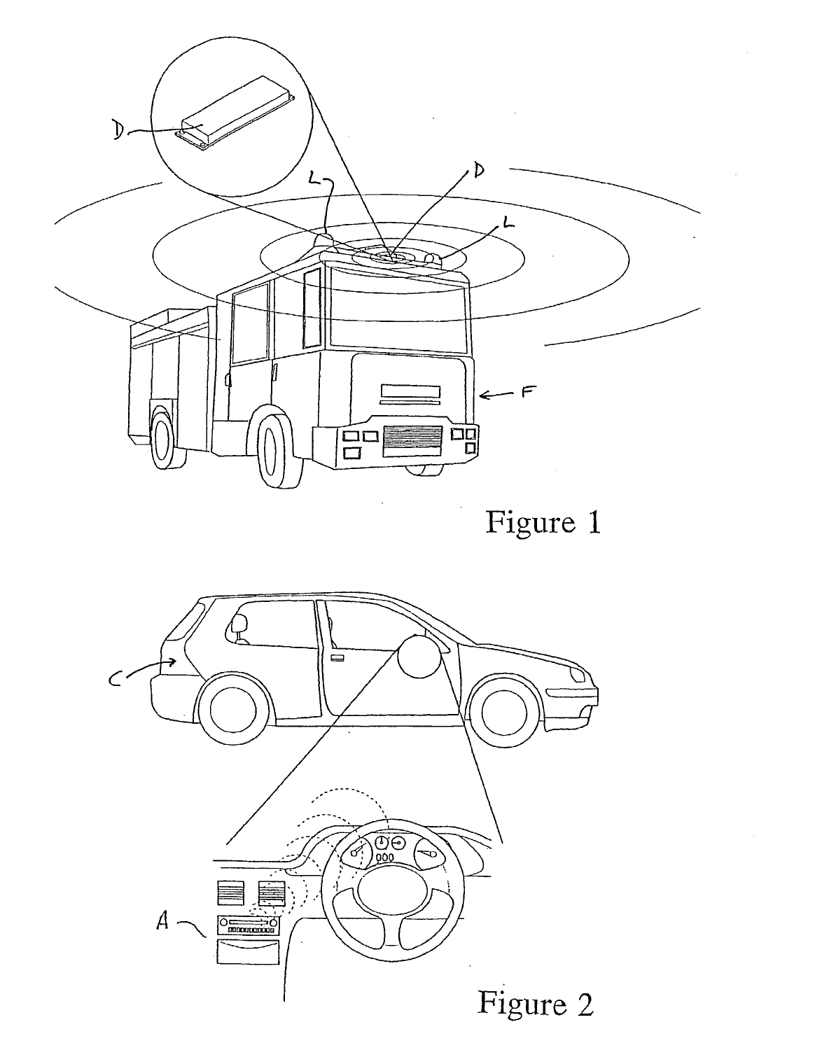

FIG. 1 is a view of a fire and rescue vehicle equipped with an emergency warning device in accordance with the present invention, the device itself being shown in inset on an enlarged scale;

FIG. 2 is a view of a car fitted with a radio receiver equipped with RDS (radio data system), part of the dashboard of the car being shown in inset on an enlarged scale; and

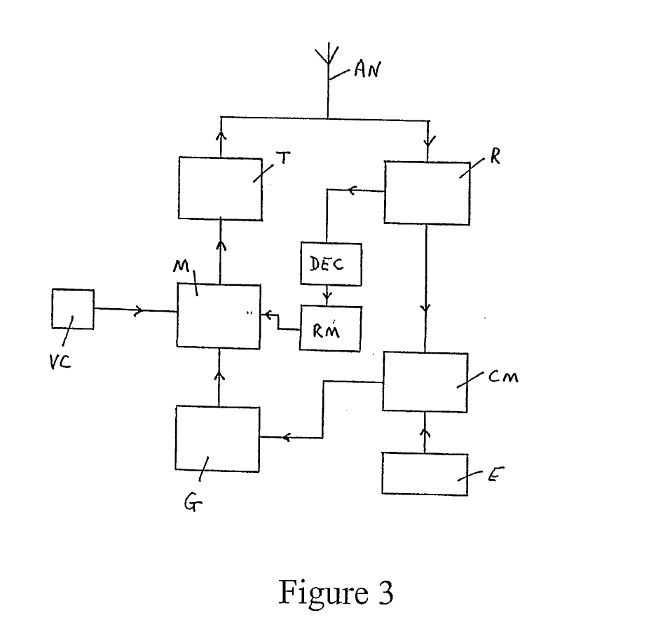

FIG. 3 is a schematic block diagram of the warning device.

Referring to FIG. 1 of the drawings, there is shown a fire and rescue vehicle F fitted, as usual, with a siren which is sounded when the vehicle is travelling through traffic to attend to an emergency incident. In addition, the fire and rescue vehicle F is fitted with a warning device D in accordance with the present invention: in the example shown, the warning device D is fitted to the roof of the driver's cab but in general may be located at any appropriate position on the vehicle. The warning device D is arranged to transmit a radio signal whilst the blue warning lights L of the vehicle are energised: in particular, the warning device D is programmed to transmit its radio signal repeatedly at successively different carrier frequencies, for a purpose which will be explained below.

The warning device D includes a voice chip or voice synthesiser and a VHF/FM radio transmitter for transmitting its radio signal, this radio signal carrying a warning message recorded in the voice chip. The warning message may be a spoken message such as “Emergency Vehicle Approaching”. The radio transmitter is of limited power, typically of the order of microwatts, feeding a suitable antenna, such that its range is of the order of 100 to 300 metres.

The purpose of the radio signal transmitted by the warning device D is that it should be picked up by the VHF/FM radio receivers of vehicles within the immediate vicinity, and the audio warning message accordingly delivered to the drivers of these vehicles. The car C shown in FIG. 2 is fitted with a VHF/FM radio receiver A equipped with RDS (radio data system).

If the emergency service vehicle of FIG. 1 approaches and transmits its radio signal at a carrier frequency identical with or close to the frequency to which the VHF/FM radio receiver A of car C is tuned, then the radio receiver A automatically retunes to the radio signal from the emergency service vehicle, because this signal will be stronger than the signal from the relevant radio transmitting station. The warning message carried in the signal from the device D of the emergency service vehicle is accordingly delivered over the car's radio receiver.

In accordance with the invention, the warning device D transmits its radio signal repeatedly at different carrier frequencies, to take account of the different vehicles in range having their VHF/FM radio receiver tuned to different channels. In any given location, there will be relatively few radio channels available, so that the warning device D need be programmed to transmit its radio signal at a correspondingly low number (e.g. 8) of different frequencies: by transmitting at these different frequencies in sequential manner, rather than simultaneously, the FM capture effect is used to ensure that the warning message will be tuned to by each of the different VHF/FM radio receivers within range. In any particular locality, it is a straightforward exercise to determine which radio channels are available, or most popular, and program the warning device accordingly.

Alternatively, the warning device D may include an FM receiver and RDS decoder, programmed to scan the FM band and determine the channels for which the received signals are strongest: the carrier frequencies of these channels are then used by the device, in sequence, to transmit the warning radio signal. In addition, the decoded RDS data is used to set RDS data to be transmitted by the device, on each of the carrier frequencies used.

Thus, the radio signal transmitted by the warning device D of the emergency service vehicle also includes RDS data which is decoded by the RDS decoder of the VHF/FM radio receivers of vehicles within range. Then a VHF/FM radio receiver with basic RDS performance, tuned to any of the frequencies transmitted in sequence by the warning device D, will receive the RDS data: this RDS data includes the PTY-Alarm signal, which will cause the receiver to be re-set to audio reception, even if the audio tape or CD is playing, and the audible warning message will be delivered.

Simultaneously, the RDS PS name carried by the warning signal serves to cause a warning message to be displayed on the visual display panel of the vehicle's audio unit A. According to the receiver type, this may be over-ridden by an ALARM message, which also serves to confirm the importance of the audio message received.

A schematic block diagram of the warning device which has been described is shown in FIG. 3. The device comprises a transmitter T feeding an aerial AN. A voice chip VC stores an audible message and its output is passed to a modulator M, which receives carrier signals, of selected different frequencies, in a repeating sequence from a carrier signal generator G. A data entry device E (e.g. a keyboard) is provided for programming a memory CM with the selected carrier frequencies. In addition or instead, the warning device D includes an FM receiver R coupled to the aerial AN and programmed to scan the FM band and determine the channels for which the received signals are the strongest, and store data as to the carrier frequencies of these channels in the carrier frequency memory CM: an RDS decoder DEC is coupled to the receiver, to store the decoded RDS data in a memory RM, to be recalled for transmission with the warning signal at the corresponding carrier frequencies.

It will be appreciated that the warning device which has been described, when fitted to an emergency service vehicle, will be effective in ensuring that other road users, having an in-vehicle, RDS-equipped VHF/FM radio receiver which is switched on, regardless of listening mode, will promptly become aware of the approach of the emergency service vehicle. This enables the other road users to take prompt action to move out of the way of the emergency service vehicle and so improve the vehicle's response time to its emergency call.

The warning device has been shown fitted to a fire and rescue vehicle but may in general be fitted to any type of emergency service vehicle, including a police motorcycle.

1) A warning device for fitting to an emergency service vehicle, the device being arranged, when activated, to transmit a radio signal carrying an audio warning, said radio signal being transmitted repeatedly at successively different carrier frequencies.

2) A warning device as claimed in claim 1, arranged to be selectively programmed with said carrier frequencies at which said radio signal is transmitted.

3) A warning device as claimed in claim 1 or 2, comprising a scanning receiver arranged to detect channels over which signals of predetermined minimum strengths are received, and to select the carrier frequencies of those channels as the carrier frequencies on which said warning radio signal is transmitted

4) A warning device as claimed in claim 3, in which said scanning radio receiver is arranged to decode RDS data of the received channels and store said RDS data.

5) A warning device as claimed in any preceding claim, arranged to include RDS data in said warning radio signal transmitted by the device.

6) A warning device as claimed in any preceding claim, in which said audio warning comprises a spoken message.

7) A warning device as claimed any preceding claim, in which the radio signal transmitter by the device has a range limited to 300 metres.
